(19) United States
(12) Patent Application Publication
(10) Pub. No.: US 2008/0010140 A1
(43) Pub. Date: Jan. 10, 2008

(54) Method of using computer memory data storage devices to distribute published information

(76) Inventor: Laura Eastwood, Santa Fe, NM (US)

Correspondence Address: DAVIDSON BERQUIST JACKSON & GOWDEY LLP, 4300 WILSON BLVD., 7TH FLOOR, ARLINGTON, VA, 22203, US

(21) Appl. No.: 11/472,333

(22) Filed: Jun. 22, 2006

(51) Int. Cl. G06Q 30/00

(52) U.S. Cl. 705/14

(57) ABSTRACT

A method of using custom USB data storage devices to market or circulate written materials, including copyrightable periodicals, promotional marketing, and invitations to personal events.

### FIELD OF INVENTION

This disclosure relates to the use of memory data storage devices such as custom USB memory sticks to market or circulate written materials, including published materials that are copyrighted or may be copyrighted.

### INTRODUCTION AND BACKGROUND

It is has long been known to circulate periodic magazines in hard copy, printed form. It has also been known to use printed flyers, leaflets, pictures or brochures to advertise or promote upcoming events, points of interest, night clubs, and restaurants. Many cities use weekly or monthly magazines to promote tourism within the city by advertising local attractions, museums, current events and activities occurring within the city. Some of these magazines or flyers are provided to local restaurants and hotels for distribution, while others may be circulated by established tourism offices. In addition, it is known within certain industries, such as fashion, to circulate printed highlights or recaps of industry events. In many cases, however, extensive printing is required. Moreover, the resulting hardcopy documents create handling and distribution issues that can prove daunting for the promoter or publisher. These hardcopy prints can also be quite voluminous, weighty or just a bother to carry, especially for people who are traveling.

Accordingly, the present inventor sought a way to provide an alternate, low weight, practical manner of distributing periodical publications and promotional materials using a custom USB memory stick or similar computer memory storage device. As described in greater detail below, the present inventor developed a method of accomplishing this result utilizing memory devices, including USB memory sticks having a shape, color, or design that reflects the nature of the publication or promotional material. The use of such a device promotes ease of carry and allows the publisher to store and distribute materials in a low cost manner.

### DESCRIPTION OF PRESENTLY PREFERRED EXEMPLARY EMBODIMENTS OF THE INVENTION

USB devices can be configured to resemble the trademark or corporate logo of the publishing company. USB devices can be formed to take on many different appearances, shapes or colors, and can be reproduced with images printed thereon.

In the first preferred embodiment of the invention, a USB memory stick is used as the electronic memory storage device. That USB memory stick may be customized in a variety of colors and shapes, to sell magazines such as Vogue, Bazaar, Time, StItch, Newsweek, and Speak (Japan). Although image and a good print is one of the main aspects of magazines, technology today provides an opportunity to take this one step further. One embodiment of the invention is to provide people “on the go” with the opportunity to buy a customized USB memory device containing the latest issue of the magazine anywhere, from their local coffee shop before going to work, or at the airport before boarding a plane. Because the vast majority of communication today takes place through computers, the use of USB memory devices provides a convenient way to communicate the magazine's content in the way technology speaks today.

The use of a USB memory device is a very practical way to sell a magazine since the USB memory stick does not weigh much, and it can fit anywhere such as in a suitcase or purse to the buyer's pocket. The shapes and colors used for each USB memory device will resemble the magazine's brands and image. The use of this structure and design allows the publisher to market its brand image while providing an easy way for the consumer to identify the magazine for purchase. For example, for Vogue, it's all about their title, with a very distinct font. Another example could be Time, they also have quite a distinct font for their title, and the unmistakable red. The idea is for people to identify them as fast as they do the paper copies on the newsstands.

In a second embodiment of the invention, customized USB memory devices are constructed for use as chains, key chains, or bracelets for night clubs and restaurants. These USB devices can be formed in a specific desirable shape to promote an event or establishment and can be used in place of flyers to advertise an upcoming event or establishment. The color may be chosen to increase its visibility or a name or photographic image may be placed thereon. The idea is to give a new “edge” using the technology available today. Instead of passing out flyers, within the premises or on the street, the promoter can hand out a USB memory device containing information and images regarding an event. One of the benefits of such an approach is getting the customer involved by down loading the USB's files to learn more about the event or establishment, and making the promotion more personal. There are artistic things that could be done with this idea as well, such as the addition of music and things of this sort, or even a link to redirect the reader to a particular web page where they can sign-up for the different events.

The USB memory device could be used to create a weekly magazine of things to do in each city, such as New York. The information conveyed, whether the USB device be distributed for free or sold, could include information on new restaurants, clubs, museum expositions, concerts or other item of interest. The idea is to provide a convenient way to learn about events occurring in each city. While event magazines and tour guides are currently published in various cities and travel destinations, the use of a USB memory device provides a fast and effective way to communicate information relating to upscale establishments to the non-tourist market such as business travellers, locals who simply like to know about new events in their area. These USB devices can also be provided with their own custom shape and color, and may also be provided with imaged photographs.

The present invention also provides a way to promote clubs and restaurants. In this embodiment, the USB memory device is sold or distributed on a weekly or monthly basis with the best photos of the different nights. Clubs and restaurants could hire a photographer who will cover each night, and then pick and choose from all the photos and put them on the USB. This application will provide the regular customers of an establishment with pictures of themselves and their friends each month. And for those who are not “usuals,” they can simply see who has attended these “hot spots” in the last month. This is approach will provide those who are quite involved in the night scene a way to see and remember what is “happening.” Also, for those party-lovers who simply like to be part of the “scene,” pictures are not the only things included on the USB memory device.

The electronic memory storage devices can also contain information about up-coming events. Once again, the USB devices will come in a variety of colors and shapes, and may be personalized with corporate logos, trademarks, names, and utilize desired colors. For those who have more than one restaurant or club, they can cross advertise their establishments by posting photos and up-coming event information on one USB.

Another application of the present invention relates to coverage of industry shows, including heavily photographed fashion events. For example, it is possible to provide full coverage of Fashion Week on a USB memory storage device. In this application, video recaps of all of the fashion shows can be provided. That recap can show the best of each show, just in case the user did not have time to make it to all of them, (or could not get invitations). This use of a custom USB memory device will provide a nice summary, easy to carry and store.

It would also be possible to load data and images relating to backstage interviews with different designers and models on the USB memory stick. This way the user can live first-hand the experience of being backstage of a fashion show, see how the models prepare to go out on the runway, and how the designers feel when they release a new line, or even make their debut. Moreover, the USB device can be used to publish photos and videos of all the parties during Fashion Week. Many different people would have interest in this information, from the fashion critiques and consultants, who would like to have a recap on a week full of work and even use these photos and videos, specifically of the runways, for future work., to the fans of the fashion world, who are very interested in fashion, but do not have access to these fashion shows or parties. This may be a way for them to follow it a bit closer.

In a fourth embodiment, the customized USB memory devices can be used for more sophisticated events, which may be bit more private. In this case, instead of sending a traditional invitation, the user can send the USB memory device (either in a small box or directly in an envelope). In this embodiment, one can also select shapes and colors or print information or pictures right on the USB device and add images and music as preferred, making this a much “hipper” and “in style” way to circulate invitations for events.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

We claim

1. A method of distributing a periodic publication comprising the steps of:
loading periodic publication information on said USB memory storage device;
distributing said USB memory storage device, wherein the USB memory storage is customized by being formed in a shape associated with a periodic publication

2. The method of claim 1 wherein the providing step includes printing the USB memory storage device with a publication logo.

3. The method of claim 2 wherein the providing step includes printing an image on the USB memory storage device.

4. The method of claim 3 wherein the providing step includes loading sound on the USB memory storage device.

5. A method of promoting an attraction comprising the steps of:
providing a portable electronic memory storage device; wherein the portable electronic memory storage device is a USB memory stick;
loading promotional information on said portable electronic memory storage device;
distributing said portable electronic memory storage device.

6. The method of claim 5 wherein the providing step includes forming the USB memory stick in a shape associated with an attraction.

7. The method of claim 6 wherein the providing step includes printing a logo associated with the attraction on the USB memory stick.

8. The method of claim 7 wherein the providing step includes printing an image associated with the attraction on the USB memory stick.

9. The method of claim 8 wherein the providing step includes loading sound associated with the attraction on the USB memory stick.

10. The method of claim 9 wherein the providing step includes loading music associated with the attraction on the USB memory stick.

11. A method of distributing invitations to an event comprising the steps of:
providing a portable electronic memory storage device; wherein the portable electronic memory storage device is a USB memory stick;
loading invitation information on said portable electronic memory storage device;
distributing said portable electronic memory storage device.

12. The method of claim 11 wherein the providing step includes loading personal information on the USB memory stick.

13. The method claim of 11 wherein the providing step includes printing an image on the USB memory stick.

14. The method claim of 11 wherein the providing step includes loading music on the USB memory stick.

15. The method claim of 11 wherein the providing step includes forming the USB memory stick in a shape associated with the event.

16. The method claim of 15 wherein the providing step includes loading personal information associated with said event on the USB memory stick.

17. A method of distributing event information comprising the steps of:
providing a portable electronic memory storage device, wherein the portable electronic memory storage device is a USB memory stick
loading event information on said portable electronic memory storage device;
distributing said portable electronic memory storage device.

18. The method of claim 17 wherein the providing step includes forming the USB memory stick in a shape associated with an event.

19. The method of claim 18 wherein the providing step includes printing an image associated with the event on the USB memory stick.

20. The method of claim 19 wherein the providing step includes loading pictures of individuals attending the event on the USB memory stick.
